(19) United States
(12) Patent Application Publication
(10) Pub. No.: US 2006/0213179 A1
(43) Pub. Date: Sep. 28, 2006

(54) Subsonic diffuser

(76) Inventors: Bobby W. Sanders, Westlake, OH (US); Charlotte A. Sanders, Westlake, OH (US); Lois J. Weir, Lakewood, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/167,733

(22) Filed: Jun. 27, 2005

Related U.S. Application Data
(60) Provisional application No. 60/582,784, filed on Jun. 25, 2004.

(51) Int. Cl. F02K 11/00

(52) U.S. Cl. 60/204; 137/15.1

(57) ABSTRACT

A subsonic diffuser is provided for decelerating airflow provided to an air-breathing engine. The subsonic diffuser includes a duct having an inlet and an outlet, and a splitter. The cross-sectional area of the duct increases from the inlet to the outlet, and the splitter delineates a plurality of passageways through the duct. During operation, the passageways divide and decelerate a subsonic airflow supplied to the subsonic diffuser, and the subsonic diffuser delivers a decelerated airflow to the air-breathing engine.

### RELATED APPLICATIONS

This application claims the benefit of U.S. provisional application Ser. No. 60/582,784 filed on Jun. 25, 2004, which is hereby incorporated by reference.

### FIELD OF THE INVENTION

This invention generally relates to aircraft propulsion systems, and more particularly, to specially-configured subsonic diffusers for high-speed inlets.

### BACKGROUND

Recently, development of high-speed inlets has concentrated on supersonic diffuser designs with different types of compression, compression splits, bleed, etc. While some significant improvements in the performance of high-speed inlets have been documented using these supersonic diffuser designs, new approaches to the design of subsonic diffusers have received very little study. Some work with vortex generators, blowing, and bleed for subsonic diffuser boundary-layer control has been completed. However, this work has mostly concentrated on subsonic diffusers that have been designed using conventional design techniques which have been used for the last forty years. While currently used high-speed inlets have provided reasonable levels of performance, potential improvements in the performance that could be realized by concentrating development efforts on new subsonic diffuser designs have mostly been ignored. Consequently, there is a need for new subsonic diffusers that can be integrated with new high-speed inlets to provide significant improvement over conventional high-speed inlets.

### SUMMARY

In general, the present invention contemplates a subsonic diffuser including a duct having an inlet and an outlet, where the cross-sectional area of the duct increases from the inlet to the outlet, and a splitter in the duct for dividing the outlet into a plurality of outlet ports.

The present invention also contemplates a method for decelerating airflow provided to an air-breathing engine using a subsonic diffuser, the method including dividing a subsonic airflow supplied to the subsonic diffuser between two passageways, decelerating the airflow in each of the two passageways, and delivering the decelerated airflow to the air-breathing engine.

The present invention also contemplates a method of designing a subsonic diffuser, the method including providing the subsonic diffuser with a specified number of splitters, arranging each of the specified number of splitters to provide at least two passageways through the subsonic diffuser, and dimensioning the length of the subsonic diffuser according to the specified number of passageways

The present invention also contemplates a subsonic diffuser including a duct having an inlet and an outlet, and a means for splitting an airflow between the inlet and the outlet.

The present invention also contemplates a subsonic diffuser including a duct having an inlet and an outlet, where the cross-sectional area of the duct increases from the inlet to the outlet, and a splitter in the duct extending from the inlet partially through the length of the duct, the splitter dividing the inlet into a plurality of inlet port

The present invention also contemplates a subsonic diffuser including a duct having an inlet and an outlet, wherein the cross-sectional area of the duct increases from the inlet to the outlet, and a splitter in the duct extending partially across the duct.

Further embodiments, variations, and enhancements are also described herein.

### DRAWINGS

FIG. 1A is a cross-sectional schematic view detailing the various sections of a bifurcated mixed compression high-speed (or supersonic) inlet including a conventional subsonic diffuser.

FIG. 1B is a cross-sectional view of single side mixed compression high-speed inlet including another type of conventional subsonic diffuser.

FIG. 1C is a cross-sectional schematic view of an external compression high-speed inlet including yet another type of conventional subsonic diffuser.

FIG. 1D is a cross-sectional schematic view of an all-internal compression high-speed inlet including yet another type of conventional subsonic diffuser.

FIG. 2A is an isometric view of the conventional subsonic diffuser depicted in FIG. 1D.

FIG. 2B is a representational isometric view of the conventional subsonic diffuser of FIG. 2A as a conical frustum.

FIG. 2C is a lengthwise cross-sectional schematic view of the conical frustum of FIG. 2B including the dimensions used in evaluating performance characteristics.

FIG. 3 is graph depicting the general performance characters associated with various subsonic diffusers having different dimensions.

FIG. 4A is a representational isometric view of a subsonic diffuser according to the present invention used in evaluating its performance characteristics.

FIG. 4B is an elevational view of one end of the subsonic diffuser of FIG. 4A.

FIG. 5A is a representational isometric view of another subsonic diffuser according to the present invention used in evaluating its performance characteristics.

FIG. 5B is an elevational view of one end of the subsonic diffuser of FIG. 5A.

FIG. 6 is graph depicting the design characteristics of subsonic diffusers having various numbers of passageways.

FIG. 7A is a representational isometric view of another subsonic diffuser according to the present invention used in evaluating its performance characteristics.

FIG. 7B is a cut-away isometric view of the subsonic diffuser depicted in FIG. 7A.

FIG. 8 is a lengthwise cross-sectional schematic view of the subsonic diffuser of FIG. 7A including the dimensions used in evaluating its performance characteristics.

FIG. 9A is a cross-sectional schematic view of an all-internal compression high-speed inlet including a subsonic diffuser according to the present invention.

FIG. 9B is a cross-sectional view of the all-internal compression high-speed inlet taken along Line 9B-9B of FIG. 9A.

FIG. 10 is an isometric view of another conventional subsonic diffuser having a square-shaped inlet throat.

FIG. 11 is a lengthwise cross-sectional schematic view of the conventional subsonic diffuser of FIG. 10 including the dimensions used in evaluating performance characteristics.

FIG. 12A is an isometric view of another subsonic diffuser according to the present invention having a square-shaped inlet throat.

FIG. 12B is a cut-away isometric view of the subsonic diffuser depicted in FIG. 12A.

FIG. 13 is a lengthwise cross-sectional view of the subsonic diffuser of FIG. 12A including the dimensions used in evaluating performance characteristics.

FIG. 14 is an isometric view of an all-internal compression high-speed inlet having a conventional diffuser with a high aspect ratio rectangular-shaped throat.

FIG. 15 is an isometric view of the conventional subsonic diffuser provided within the all-internal compression high-speed inlet of FIG. 14.

FIG. 16A is an isometric view of another subsonic diffuser according to the present invention having a rectangular-shaped throat.

FIG. 16B is a cut-away isometric view of the subsonic diffuser depicted in FIG. 17A.

FIG. 17A is a lengthwise cross-sectional schematic view of another subsonic diffuser according to the present invention including one splitter providing two airflow passageways.

FIG. 17B is a cross-sectional view of one end of the subsonic diffuser taken along Line 17B-17B of FIG. 17A.

FIG. 17C is a cross-sectional view of the other end of the subsonic diffuser taken along Line 17C-17C of FIG. 17A.

FIG. 18A is a lengthwise cross-sectional view of another subsonic diffuser according to the present invention including two splitters providing four airflow passageways.

FIG. 18B is a cross-sectional view of one end of the subsonic diffuser taken along Line 18B-18B of FIG. 18A.

FIG. 18C is a cross-sectional view of the other end of the subsonic diffuser taken along Line 18C-18C of FIG. 18A.

FIG. 19A is a lengthwise cross-sectional view of another subsonic diffuser according to the present invention including one splitter providing two airflow passageways.

FIG. 19B is a cross-sectional view of one end of the subsonic diffuser taken along Line 19B-19B of FIG. 19A.

FIG. 19C is a cross-sectional view of the other end of the subsonic diffuser taken along Line 19C-19C of FIG. 19A.

FIG. 20A is a lengthwise cross-sectional view of another subsonic diffuser according to the present invention including two splitters providing three airflow passageways.

FIG. 20B is a cross-sectional view of one end of the subsonic diffuser taken along Line 20B-20B of FIG. 20A.

FIG. 20C is a cross-sectional view of the other end of the subsonic diffuser taken along Line 20C-20C of FIG. 20A.

FIG. 21A is a lengthwise cross-sectional view of another subsonic diffuser according to the present invention having one splitter moveable between two positions.

FIG. 21B is a cross-sectional view of one end of the subsonic diffuser taken along Line 21B-21B of FIG. 21A.

FIG. 21C is a cross-sectional view of the other end of the subsonic diffuser taken along Line 21C-21C of FIG. 21A.

FIG. 22A is a lengthwise cross-sectional view of another subsonic diffuser according to the present invention having a segmented splitter with a segment moveable between two positions.

FIG. 22B is a cross-sectional view of one end of the subsonic diffuser taken along Line 22B-22B of FIG. 22A.

FIG. 22C is a cross-sectional view of the other end of the subsonic diffuser taken along Line 22C-22C of FIG. 22A.

FIG. 23A is a lengthwise cross-sectional view of another subsonic diffuser according to the present invention having a splitter extending only partially along the length of the subsonic diffuser.

FIG. 23B is a cross-sectional view of one end of the subsonic diffuser taken along Line 23B-23B of FIG. 23A.

FIG. 23C is a cross-sectional view of the other end of the subsonic diffuser taken along Line 23C-23C of FIG. 23A.

FIG. 24 is a cut-away isometric view of another subsonic diffuser according to the present invention.

FIG. 25A is a lengthwise cross-sectional view of the subsonic diffuser taken along Line 25A-25A of FIG. 24.

FIG. 25B is a cross-sectional view of one end of the subsonic diffuser taken along Line 25B-25B of FIG. 25A.

FIG. 25C is a cross-sectional view of the other end of the subsonic diffuser taken along Line 25C-25C of FIG. 25A.

### DETAILED DESCRIPTION OF THE INVENTION

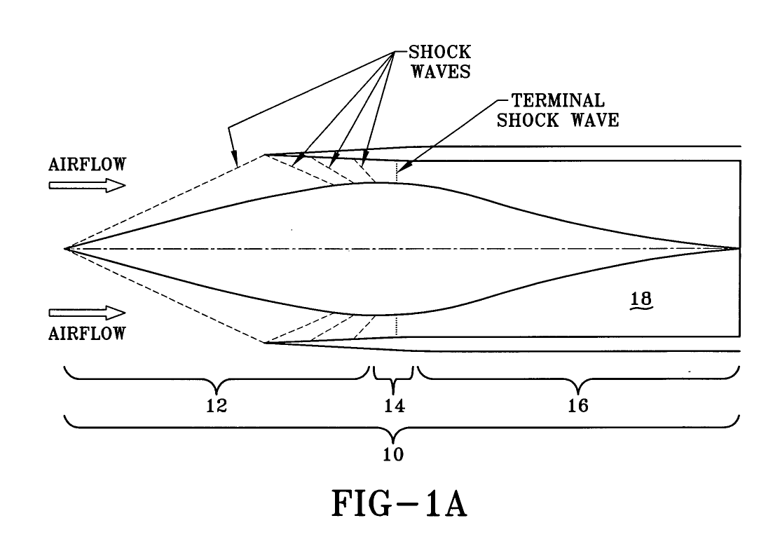

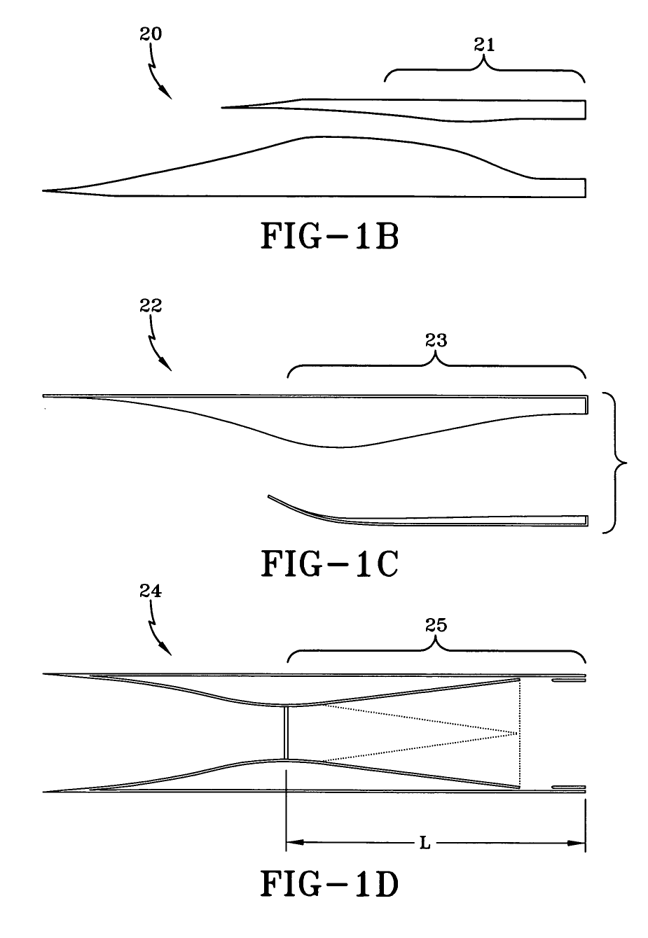

Typical high-speed (or supersonic) inlets used with various aircraft propulsion systems associated with air-breathing engines are depicted in FIGS. 1A-1D. Each of the high-speed inlets depicted in FIGS. 1A-1D includes a subsonic diffuser which can be modified according to the present invention. As shown in FIG. 1A, a bifurcated mixed compression high-speed inlet generally indicated by the numeral 10 has various sections including a supersonic diffuser 12, a throat 14, and a conventional subsonic diffuser 16. Note that the cross-section of FIG. 1A could also represent an axisymmetric inlet in which the subsonic diffuser associated therewith transitions from an annular throat cross-section to the round air-breathing engine.

The supersonic diffuser 12 decelerates the airflow entering the high-speed inlet 10 using a series of weak shock waves. In doing so, the supersonic diffuser decreases the speed of the airflow from a supersonic speed (i.e. high Mach number) to a low supersonic speed of about 1.2 to 1.3 times the speed of sound at the entrance to the throat 14. Thereafter, the speed of the airflow is decreased from the low supersonic speed of about 1.2 to 1.3 times the speed of sound to a high subsonic speed by a terminal shock wave inside throat 14. The high subsonic speed of the airflow is further reduced using the subsonic diffuser 16.

As shown in FIG. 1A, the high subsonic speed of the airflow is reduced in the subsonic diffuser 16 by an increase in cross-sectional area of the passageway or duct 18. The conventional subsonic diffusers depicted in FIGS. 1B, 1C, and 1D are configured in a similar manner. For example, FIG. 1B depicts a single side mixed compression high-speed inlet 20 having a subsonic diffuser 21, FIG. 1C depicts an external compression high-speed inlet 22 having a subsonic diffuser 23, and FIG. 1D depicts an all-internal compression high-speed inlet 24 including a subsonic diffuser 25. Each of the conventional subsonic diffusers 16, 21, 23, and 25 have different configurations, and each can be modified according to the present invention. In doing so, the resulting subsonic diffusers can have shortened lengths relative to the conventional subsonic diffusers 16, 21, 23, and 25, and have substantially similar performance characteristics. The shortened lengths of the resulting subsonic diffusers advantageously decrease the weight of the resulting high-speed inlets, thereby increasing the efficiency of the associated aircraft propulsion systems. The shortened lengths of the resulting subsonic diffusers also provide for shortened aircraft propulsion systems which offers more options for integration in aircraft.

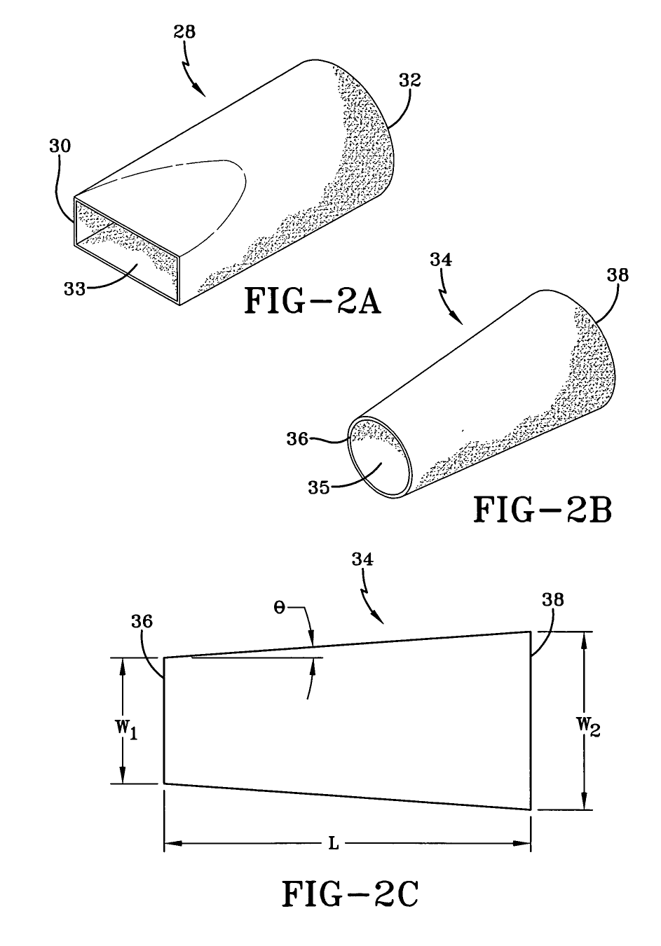

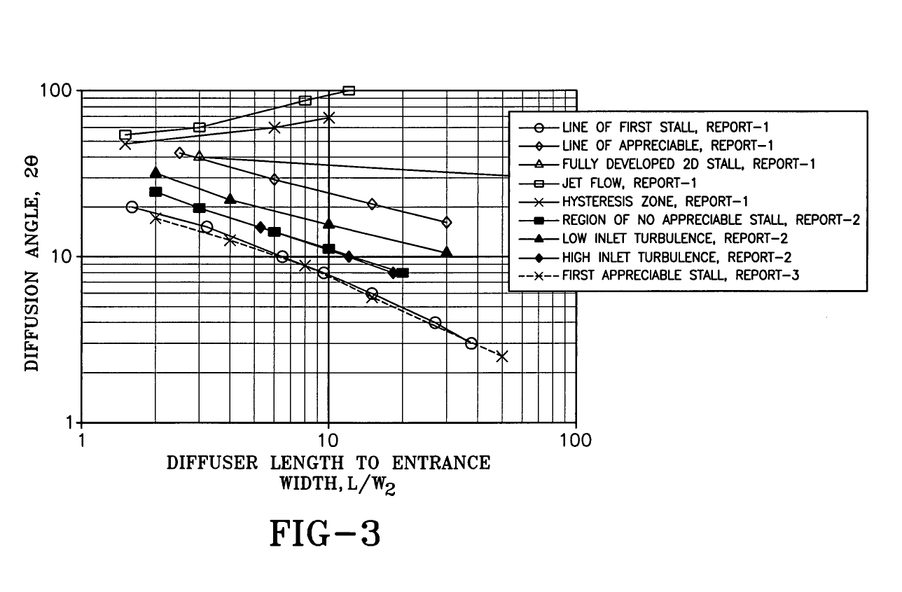

Basic subsonic diffuser nomenclature and diffusion characteristics are presented in FIGS. 2A, 2B, 2C, and 3. Performance characteristic curves according the dimensions of various subsonic diffusers are shown in FIG. 3. The performance characteristic curves of FIG. 3 are a composite of many different research studies on a variety of subsonic diffusers having a variety of cross-sectional shapes as well as off-sets, etc. The performance characteristic curves of FIG. 3 are used as a guide to determine acceptable dimensions for the length, entrance width, and diffusion angle to avoid airflow separation in subsonic diffusers. If the relationship between the length, entrance width, and diffusion angle on FIG. 3 falls within the region of no appreciable stall, the subsonic diffuser having these dimensions should avoid airflow separation, and should yield acceptable performance and distortion.

For example, a conventional subsonic diffuser 28 is shown in FIG. 2A having an inlet throat (or entrance) 30, an outlet 32, and a single duct 33 extending between the inlet throat 30 and outlet 32. The typical approach to providing the subsonic diffuser 28 with acceptable dimensions according to the performance characteristic curves of FIG. 3 is to define a circle representing the desired area of the inlet throat 30, and, thereafter, represent the conventional subsonic diffuser 28 as the conical frustum 34 shown in FIG. 2B including a single duct 35. Because one end 36 of the conical frustum 34 is defined by the aforementioned circle, and the other end 38 is defined by the air-breathing engine, the conical frustum 34 has known values for the minimum diameter and maximum diameter. As such, because diffusion angles of about 6° to 8° are typically provided, the appropriate length of the conical frustum 34 can be determined using FIG. 3. For simplicity, the conical frustum 34 can be reduced to a two-dimensional form depicted in FIG. 2C having a length L, an entrance width W₁ equal to its minimum diameter, an outlet width W₂ equal to its maximum diameter, and a half angle ⊖ (equal to one half the diffusion angle 2⊖).

The performance characteristic curves of FIG. 3 are the basis for the development of specially-configured subsonic diffusers according to the present invention. Generally, the specially-configured subsonic diffusers depicted in the accompanying drawings are formed as a duct including a splitter used to split the airflow passing through the diffuser between a plurality of airflow passageways. The ducts and/or the passageways defined by the splitters increase in cross-sectional area between the inlets and outlets of the specially-configured subsonic diffusers. For example, FIGS. 4A and 4B depict a subsonic diffuser 40 having a splitter 41 defining a first passageway 42 and a second passageway 43. Furthermore, FIGS. 5A and 5B depict a subsonic diffuser 46 having two splitters 48 and 49 defining a first passageway 50, a second passageway 51, a third passageway 52, and a fourth passageway 53. As shown in FIGS. 4A and 4B, the splitter 41 bisects the subsonic diffuser 40, and, as shown in FIGS. 4A and 4B, the two splitters 48 and 49 are arranged at ninety degrees with respect to one another.

Each of the plurality of passageways shown in FIGS. 4A, 4B, 5A and 5B should exhibit performance characteristics (e.g. providing a specified rate of diffusion) according to the performance characteristic curves of FIG. 3. For example, basic geometric calculations show that, when a subsonic diffuser formed as a conical frustum having a single duct is modified to incorporate a splitter defining two passageways (and the length of the conical frustum remains unchanged), conical diffusion calculations for the resulting two passageways will indicate that the diffusion angle 2⊖ has been reduced by one half. Due to the reduction of the diffusion angle 2⊖ by one half, a subsonic diffuser resulting from the use of the single splitter, such as subsonic diffuser 40 shown in FIGS. 4A and 4B, offers some improvement in performance according to FIG. 3, but also has increased weight. The same holds true for subsonic diffuser 46 shown in FIGS. 5A and 5B. That is, the subsonic diffuser shown in FIGS. 5A and 5B offers some improvement in performance according to FIG. 3, but also has increased weight.

According to FIG. 3, however, the subsonic diffusers 40 and 46 can be shortened to compensate for the increased weight of their splitters, and still benefit from the performance provided by the use of splitters. The shortened lengths of the subsonic diffusers 40 and 46 should provide for weight reductions, even after accounting for the weight of the splitters. For example, the length of the subsonic diffusers 40 and 46 can be reduced so that the diffusion angles 2⊖ associated with their passageways are the same as that of the subsonic diffuser formed as a conical frustum having a single duct. The resulting subsonic diffusers will have shortened lengths, and because of the performance improvements provided by the splitters, have similar performance characteristics as the longer subsonic diffuser formed as a conical frustum having a single duct.

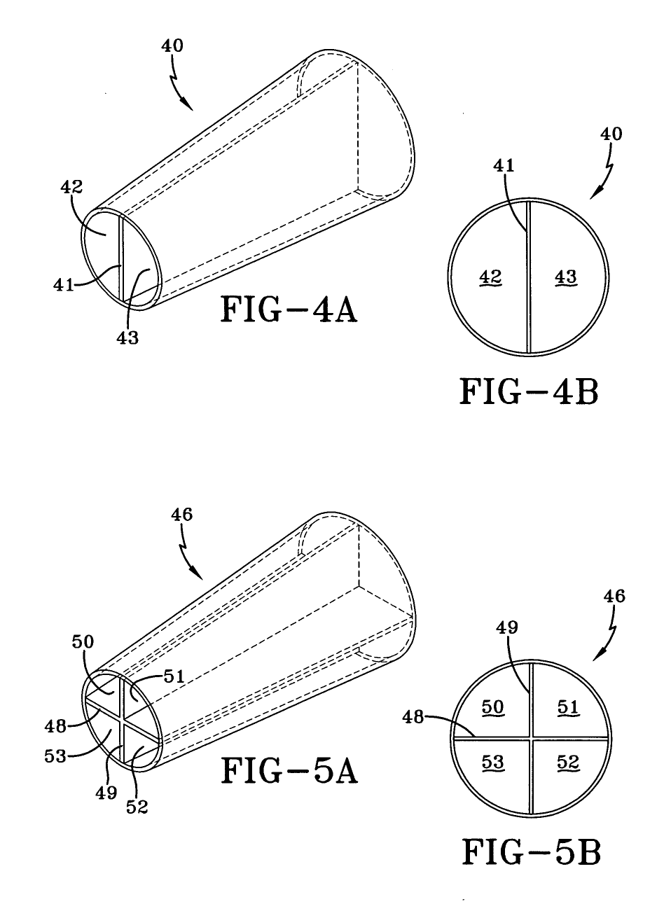

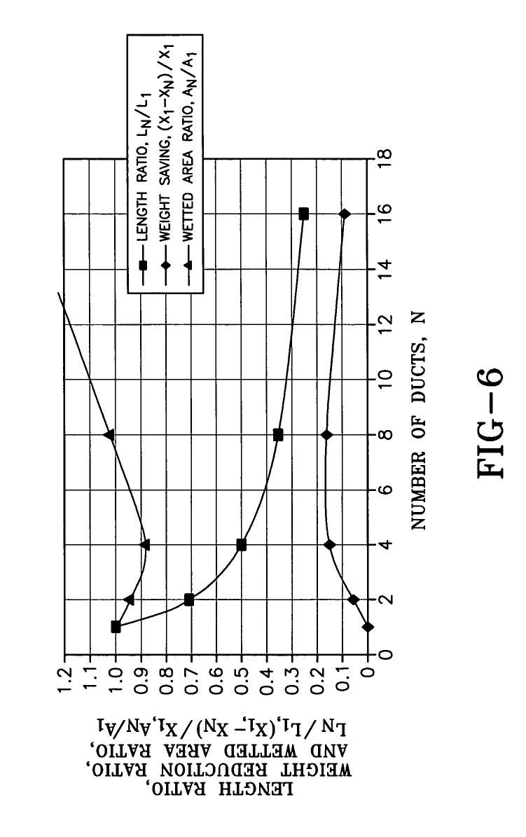

A graph depicting the design characteristics of subsonic diffusers having various numbers of passageways provided by the splitters is shown in FIG. 6. The graph of FIG. 6 shows the dimensional relationship between subsonic diffusers with various numbers of passageways N, and an equivalent subsonic diffuser formed as a conical frustum with a single duct. The subsonic diffuser formed as an equivalent conical frustum with a single duct would have a length L₁, a weight X₁, and wetted area A₁, and the subsonic diffusers with various numbers of passageways N would have lengths L_{N}, weights X_{N}, and wetted areas A_{N}. For example, the graph of FIG. 6 indicates that a subsonic diffuser having four passageways, such as the subsonic diffuser 54 shown in FIGS. 7A and 7B, when compared to subsonic diffuser formed as an equivalent conical frustum with a single duct, will result in a length ratio of about 50%, a weight reduction ratio of about 16%, and a wetted area ratio of about 89%.

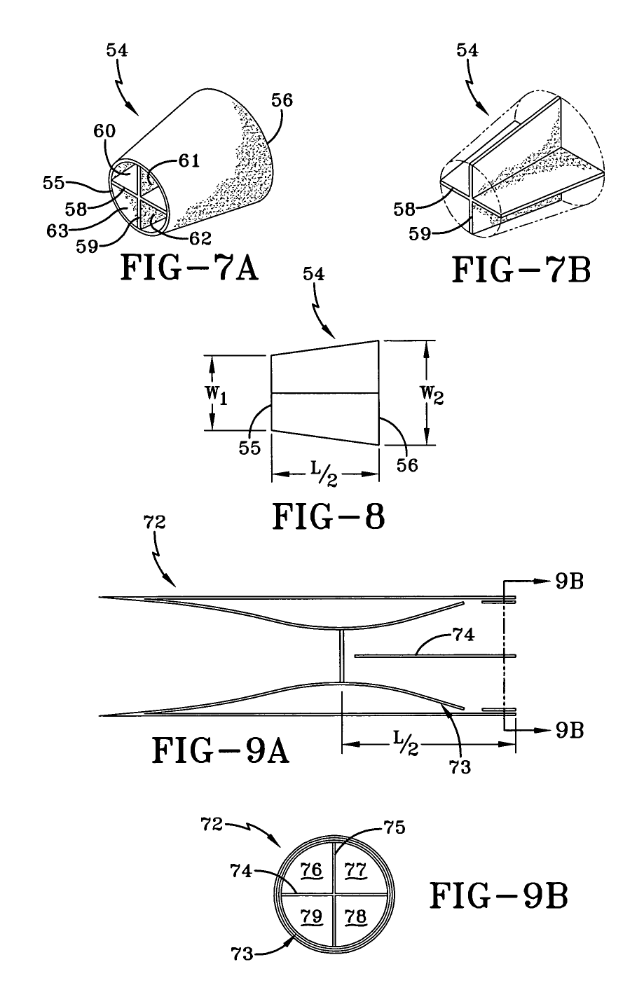

As shown in FIGS. 7A and 7B, the subsonic diffuser 54 includes an inlet throat (or entrance) 55, an outlet 56, and two splitters 58 and 59. Each of the two splitters 58 and 59 are provided in different planes that intersect with one another. The two splitters 58 and 59 are oriented at ninety degrees with respect to one another, and define four passageways 60, 61, 62 and 63. The subsonic diffuser 54 can be reduced to a two-dimensional form depicted in FIG. 8. Using FIG. 8, the dimensions of the subsonic diffuser 54 can be compared to the dimensions of a subsonic diffuser formed as an equivalent conical frustum having a single duct. For example, if the subsonic diffuser 54 had a diffusion angle 2⊖ equivalent to that of the conical frustum 34 (the dimensions of which are shown in FIG. 2C), the subsonic diffuser 54 and the conical frustum 34 would have the same entrance width W₁ and outlet width W₂, but the subsonic diffuser 54 would have one half the length (L/2) of the length L of the conical frustum 34.

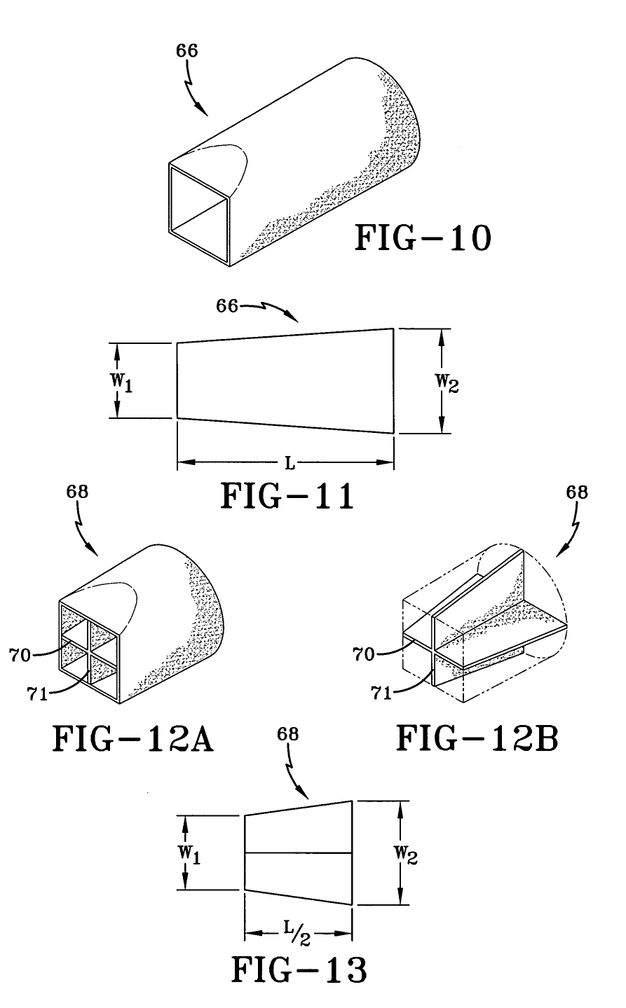

A similar comparison can be illustrated using FIGS. 10, 11, 12A, 12B, and 13. For example, FIG. 10 depicts a subsonic diffuser 66 with a square-shaped inlet throat, a circular-shaped outlet, and a single duct extending therebetween, and FIGS. 12A and 12B depict an equivalent subsonic diffuser 68 with four passageways (formed by two splitters 70 and 71), a square-shaped inlet throat, and a circular-shaped outlet. Because the subsonic diffusers 66 and 68 have equivalent diffusion angles 2⊖, the subsonic diffusers 66 and 68 (represented in two-dimensional form in FIGS. 11 and 13, respectively) will have the same entrance width W₁ and outlet width W₂, but the subsonic diffuser 68 would have one half (L/2) of the length L of the subsonic diffuser 66.

Because subsonic diffusers according to the present invention have shortened lengths, the lengths of the resulting high-speed inlets incorporating such subsonic diffusers will also be shortened. For example, an all-internal compression high-speed inlet is generally indicated by the numeral 72 in FIGS. 9A and 9B. Rather than incorporating the conventional subsonic diffuser 25 associated with the all-internal compression high-speed inlet 24 depicted in FIG. 1D, the high-speed inlet 72 includes a subsonic diffuser 73 according to the present invention. The subsonic diffuser 73 includes two splitters 74 and 75, each provided in different planes that intersect with one another. The two splitters 74 and 75 are oriented at ninety degrees with respect to one another, and define four passageways 76, 77, 78 and 79 (FIG. 9B). Because of the performance improvements provided by the four passageways 76, 77, 78, and 79, and because the subsonic diffuser 73 has a diffusion angle 2⊖ equivalent to that of the subsonic diffuser 25, the subsonic diffuser 73 would have one half (L/2) the length L of the subsonic diffuser 25. As such, the high-speed inlet 70 would have a shorter length than the subsonic diffuser 25, and, therefore benefit from the resulting weight reduction.

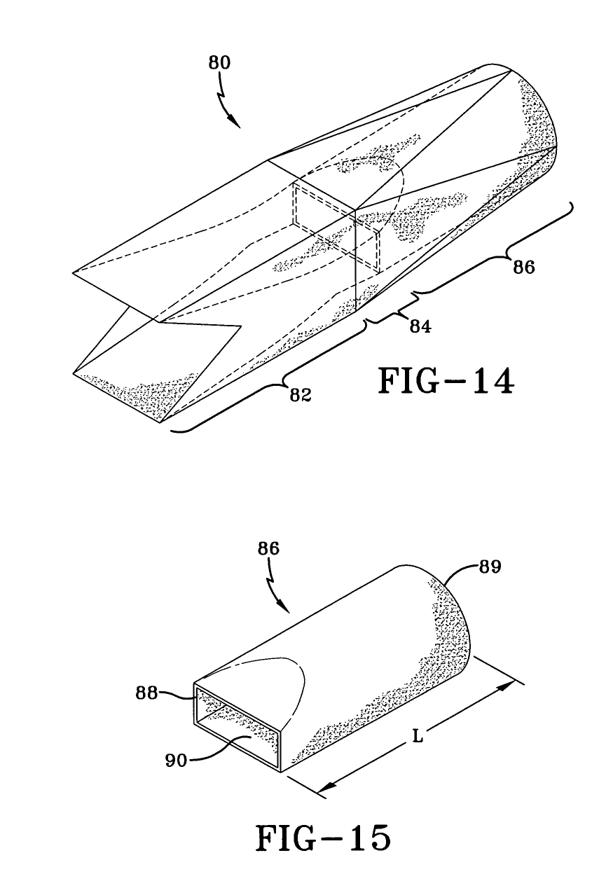

Additionally, a subsonic diffuser according to the present invention could be incorporated into a high-performance, low-sonic-boom, high-speed 80 inlet depicted in FIG. 14. As shown in FIG. 14, the high-speed inlet 80 includes a supersonic diffuser 82, a throat 84, and a conventional subsonic diffuser 86 (FIG. 15). The supersonic diffuser 82 of the high-speed inlet 80 should have very high performance and operability. If the supersonic diffuser 82 was integrated with a subsonic diffuser according to the present invention, rather than the subsonic diffuser 86, a significant increase in the efficiency for a high-speed inlet could nevertheless result. As shown in FIG. 15, the subsonic diffuser 86 has a rectangular-shaped inlet throat 88, a circular-shaped outlet 89, and a single duct 90 extending therebetween. In the manner described above, the subsonic diffuser 86 could be shortened using splitters. The resulting subsonic diffuser 92 incorporating two splitters 94 and 95 is shown in FIGS. 16A and 16B. The subsonic diffuser 92 has a rectangular-shaped inlet 96, a circular-shaped outlet 97, and four passageways 98, 99, 100, and 101 extending therebetween. Provided the subsonic diffuser 92 has a diffusion angle 2⊖ equivalent to that of the subsonic diffuser 86, the subsonic diffusers will have the same entrance width and outlet width, but the subsonic diffuser 92 would have one half the length of the subsonic diffuser 86.

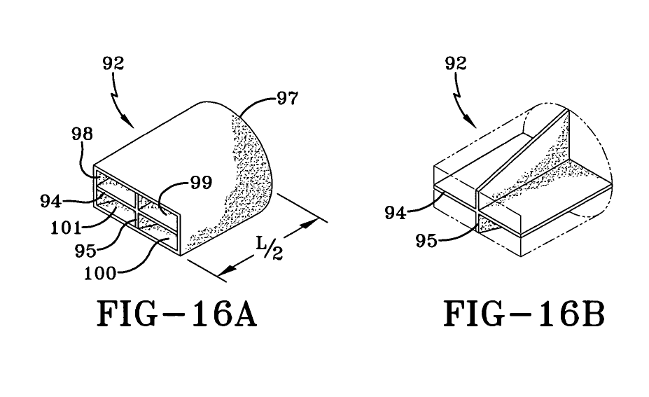

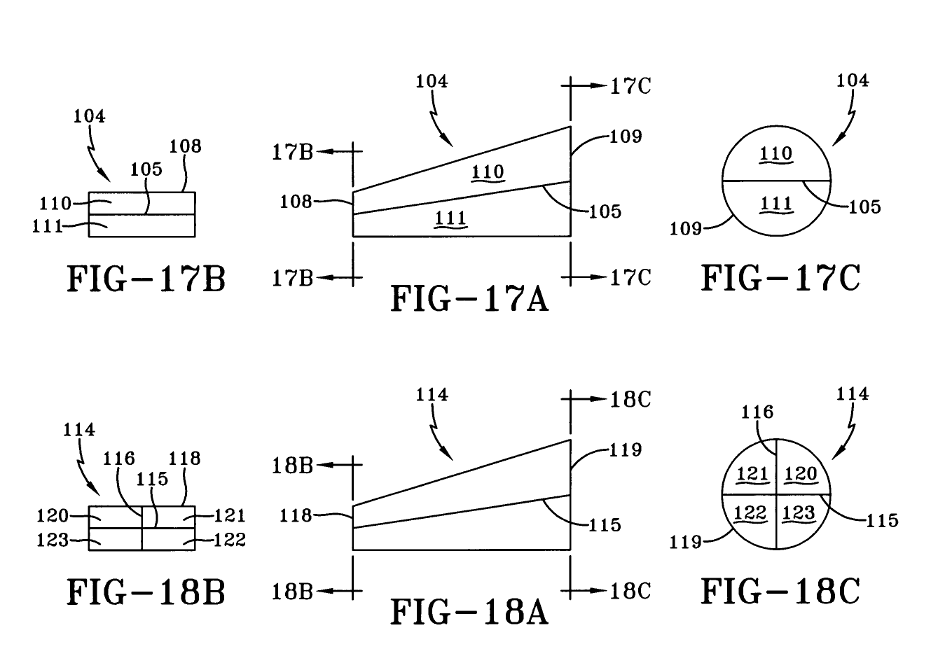

For illustrative purposes, other embodiments of the subsonic diffusers according to the present invention are depicted in the remaining drawings. The subsonic diffusers depicted in the remaining drawings include splitters in various arrangements. FIGS. 17A-17C depict a subsonic diffuser 104 having one splitter 105. The subsonic diffuser 104 includes a rectangular-shaped entrance throat 108, a circular-shaped outlet 109, and two passageways 110 and 111 defined by the splitter 105.

FIGS. 18A-18C depict a subsonic diffuser 114 having two splitters 115 and 116 provided in different planes that intersect with one another at ninety degrees. The subsonic diffuser 114 includes a rectangular-shaped entrance throat 118, a circular-shaped outlet 119, and four passageways 120, 121, 122 and 123 defined by the two splitters 115 and 116.

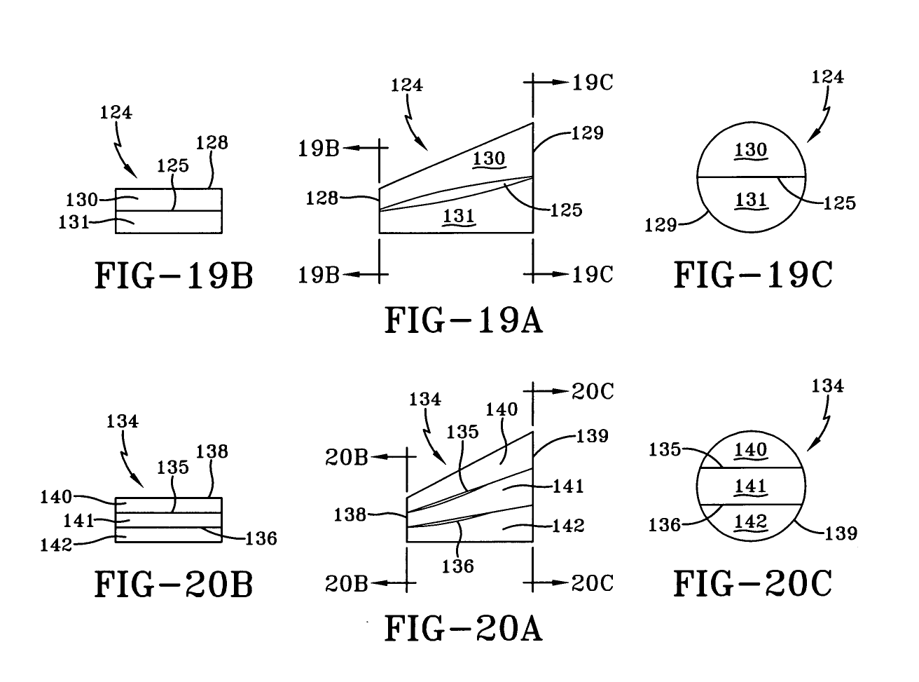

FIGS. 19A-19C depict a subsonic diffuser 124 having one splitter 125 which can be formed as an airfoil. The subsonic diffuser 124 includes a rectangular-shaped entrance throat 128, a circular-shaped outlet 129, and two passageways 130 and 131 defined by the splitter 125.

FIGS. 20A-20C depict a subsonic diffuser 134 having two splitters 135 and 136 which can be contoured. The two splitters 135 can be oriented parallel to one another (FIGS. 20B and 20C), and 136 can be shaped as airfoils or have some other configurations. The subsonic diffuser 134 includes a rectangular-shaped entrance throat 138, a circular shaped outlet 139, and three passageways 140, 141 and 142 defined by the two splitters 135 and 136.

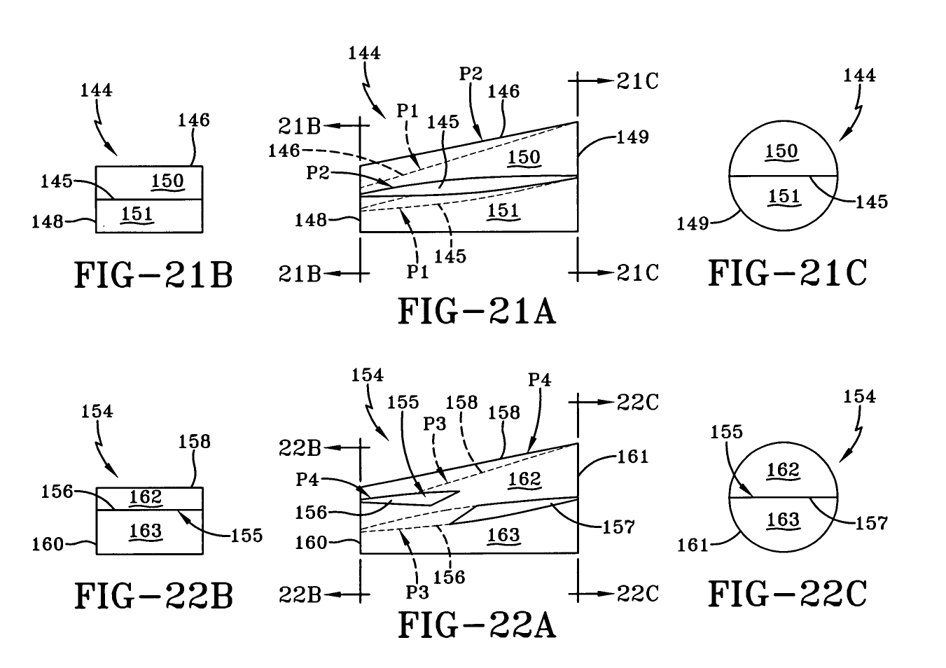

FIGS. 21A-21C depict a subsonic diffuser 144 having one splitter 145 which can be formed as an airfoil. The subsonic diffuser 144 is adapted for inlet variable geometries. For example, the splitter 145 is configured to move with a moveable wall 146 between a design position P1 and an off-design position P2. The subsonic diffuser 144 includes rectangular-shaped entrance throat 148 (of variable dimensions), a circular-shaped outlet 149, and two variably-sized passageways 150 and 151.

FIGS. 22A-22C depict a subsonic diffuser 154 having a segmented splitter 155 with a stationary segment 157 and a moveable segment 156. The subsonic diffuser 154 is also adapted for inlet variable geometries. For example, the moveable segment 156 is configured to move with a moveable wall 158 between a design position P3 and an off-design position P4. The subsonic diffuser 154 includes a rectangular-shaped entrance throat 160 (of variable dimensions), a circular-shaped outlet 161, and two passageways 162 and 163. Movement of the moveable segment 156 to the off-design position P4 joins the two passageways 162 and 163 to further alter the airflow.

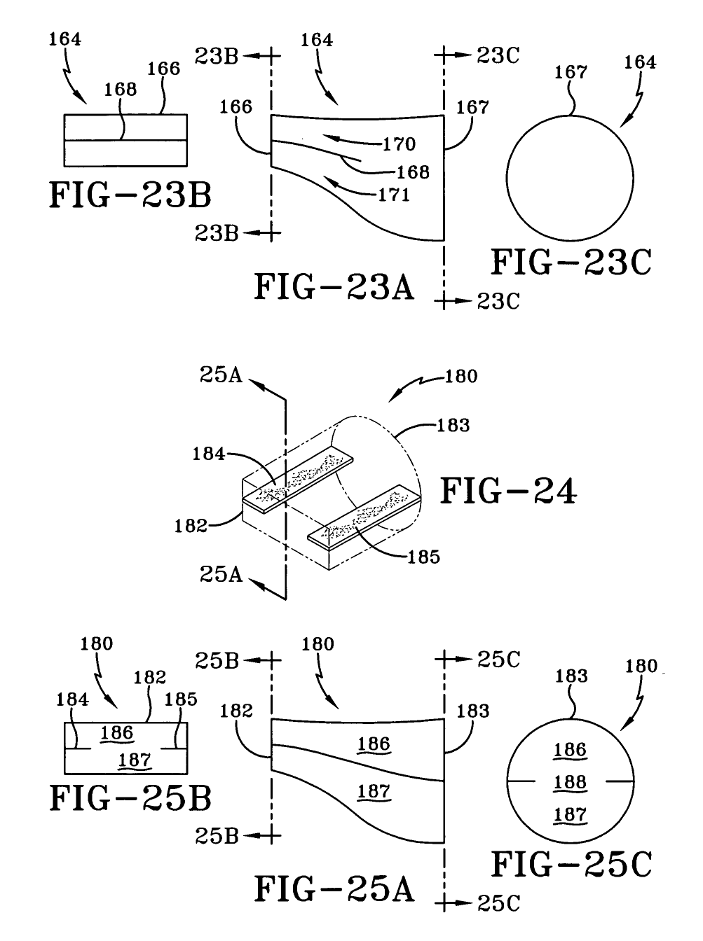

FIGS. 23A-23C depict a subsonic diffuser 164 having a rectangular-shaped inlet 166 and a circular-shaped outlet 167. One splitter 168 extends from the rectangular-shaped inlet 166 only partially through the length of the subsonic diffuser 164. As such, the splitter 168 defines two passageways 170 and 171 adjacent the rectangular-shaped inlet 166. Additional splitters extending partially through the subsonic diffuser 164 can also be provided. For example, two splitters can be oriented parallel to one another to provide three passageways adjacent the rectangular-shaped inlet 166. Furthermore, two splitters can be provided in different planes that intersect with one another to provide four passageways adjacent the rectangular-shaped inlet 166.

FIGS. 24, and 25A-25C depict a subsonic diffuser 180 having at least one splitter extending partially across the span thereof. The subsonic diffuser 180 includes a rectangular-shaped inlet 182 and a circular-shaped outlet 183. As shown in FIGS. 24, 25B and 25C, two splitters 184 and 185, although only one can be provided, extend partially across the subsonic diffuser 180. A first passageway 186 is effectively defined above the two splitters 184 and 185, and a second passageway 187 is effectively defined below the two splitters 184 and 185. The first and second passageways 186 and 187 communicate with one another via a gap 188 between the two splitters 184 and 185. Like the splitter 168 of the subsonic diffuser 164, the two splitters 184 and 185 can be configured to extend only partially through the length of the subsonic diffuser 180.

1. A subsonic diffuser, comprising:
a duct having an inlet and an outlet, wherein the cross-sectional area of said duct increases from said inlet to said outlet, and
a splitter in said duct, said splitter dividing the outlet into a plurality of outlet ports.

2. A subsonic diffuser according to claim 1, wherein said splitter extends between said inlet and said outlet.

3. A subsonic diffuser according to claim 2, wherein said splitter divides said duct into two passageways.

4. A subsonic diffuser according to claim 3, further including a second splitter provided in said duct.

5. A subsonic diffuser according to claim 4, wherein said two splitters intersect with one another.

6. A subsonic diffuser according to claim 5, wherein said two splitters are oriented at ninety degrees with respect to one another.

7. A subsonic diffuser according to claim 4, wherein each of said two splitters is provided in a different plane.

8. A subsonic diffuser according to claim 4, further including a third splitter provided in said duct.

9. A subsonic diffuser according to claim 8, wherein said three splitters intersect with one another.

10. A subsonic diffuser according to claim 9, wherein said three splitters are oriented at sixty degrees with respect to one another.

11. A subsonic diffuser according to claim 8, wherein each of said three splitters is provided in a different plane.

12. A method for decelerating airflow provided to an air-breathing engine using a subsonic diffuser, the method comprising:
dividing a subsonic airflow supplied to the subsonic diffuser between two passageways;
decelerating the airflow in each of the two passageways; and
delivering the decelerated airflow to the air-breathing engine.

13. A method according to claim 12, further comprising the step of expanding the volume of the airflow through each of the two passageways.

14. A method according to claim 12, further comprising the step of splitting the subsonic airflow using a splitter.

15. A method according to claim 14, wherein a first splitter is provided, the first splitter providing the two passageways between which the subsonic airflow is divided.

16. A method according to claim 15, wherein a second splitter is provided which intersects with the first splitter, the two intersecting splitters providing four passageways between which the subsonic airflow is divided.

17. A method of designing a subsonic diffuser, the method comprising:
providing the subsonic diffuser with a specified number of splitters;
arranging each of the specified number of splitters to provide at least two passageways through the subsonic diffuser; and
dimensioning the length of the subsonic diffuser according to the specified number of passageways.

18. A method according to claim 17, further comprising the step of dimensioning the length of the subsonic diffuser according to a specified rate of diffusion.

19. A subsonic diffuser, comprising:
a duct including an inlet and an outlet, and
a means for splitting an airflow between said inlet and said outlet.

20. A subsonic diffuser according to claim 19, wherein said means for splitting the airflow includes a divider provided in said duct.

21. A subsonic diffuser according to claim 20, further comprising a means for reducing a velocity of the airflow.

22. A subsonic diffuser, comprising:
a duct having an inlet and an outlet, wherein the cross-sectional area of said duct increases from said inlet to said outlet, and
a splitter in said duct extending from said inlet partially through the length of said duct, said splitter dividing the inlet into a plurality of inlet ports.

23. A subsonic diffuser according to claim 22, wherein said splitter delineates two passageways in said duct.

24. A subsonic diffuser according to claim 23, further including a second splitter provided in said duct.

25. A subsonic diffuser according to claim 24, wherein each of said two splitters is provided in a different plane.

26. A subsonic diffuser according to claim 25, further including a third splitter provided in said duct.

27. A subsonic diffuser according to claim 26, wherein each of said three splitters is provided in a different plane.

28. A subsonic diffuser, comprising:
a duct having an inlet and an outlet, wherein the cross-sectional area of said duct increases from said inlet to said outlet, and
a splitter in said duct extending partially across said duct.

29. A subsonic diffuser according to claim 28, further including a second splitter extending partially across said duct.
